(19) United States
(12) Patent Application Publication
(10) Pub. No.: US 2016/0057564 A1
(43) Pub. Date: Feb. 25, 2016

(54) BLUETOOTH PAIRING METHOD USING A WIRED CONNECTION

(71) Applicant: HYUNDAI MOTOR COMPANY, Seoul (KR)

(72) Inventor: Hyun Chul SIM, Suwon-si (KR)

(73) Assignee: HYUNDAI MOTOR COMPANY, Seoul (KR)

(21) Appl. No.: 14/563,549

(22) Filed: Dec. 8, 2014

(30) Foreign Application Priority Data
Aug. 25, 2014 (KR) 10-2014-0110938

(51) Int. Cl. H04W 4/00; H04W 76/02

(52) U.S. Cl. CPC H04W 4/008; H04W 76/023

(57) ABSTRACT

A Bluetooth pairing method using a wired connection comprises steps of: connecting a mobile terminal and an infotainment system of a vehicle via a wired connection; inputting a control signal starting a Bluetooth pairing; executing a dedicated application for a Bluetooth pairing provided in the mobile terminal by a controller provided in the infotainment system; transmitting information of the infotainment system for the Bluetooth pairing to the dedicated APP by the controller; and automatically executing a connection screen for the Bluetooth pairing by controlling the mobile terminal based on the information by the dedicated application, wherein the connection screen is a screen displaying the information of the infotainment system.

### CROSS-REFERENCE TO RELATED APPLICATION

This application is based on and claims priority from Korean Patent Application No. 10-2014-0110938, filed on Aug. 25, 2014 in the Korean Intellectual Property Office, the disclosure of which is incorporated herein in its entirety by reference.

### FIELD OF THE INVENTION

The present disclosure relates to a Bluetooth pairing method, and more particularly, a Bluetooth pairing method using a wired connection, in which a Bluetooth is paired without a separate complicated process, after connecting devices via a wired connection.

### DESCRIPTION OF THE PRIOR ART

Since a phone call while driving may distract the driver's attention, in order to prevent this, the hands-free phone call has been widely used for enabling the driver to concentrate on driving without the use of hands.

Early hands-free device is implemented in a wired way which is mounted on a mobile phone holder, but in recent years, the product, which Bluetooth technology is applied to and thus enables the phone call to be placed even while leaving the mobile phone in a bag or pocket, has gained popularity.

The Bluetooth is the technology according to a specification of the IEEE 802.15.1 short-range wireless communication technology, and it allows the electronic devices such as a wireless terminal located within about 10 m, for example, a computer, a cell phone, a headset, a PDA, a printer, a mouse, a keyboard and the like to wirelessly communicate with each other in a low cost and low power.

Bluetooth hands-free device outputs the audio signal transmitted from the paired mobile phone or MP3 player through the speaker provided in a vehicle, and transmits the user's voice signal inputted through the microphone provided in the vehicle to the mobile phone when call function of the mobile phone is used.

In particular, the general Bluetooth pairing procedure between a head unit of a vehicle and a mobile terminal of a user is complicated. Concretely, the pairing can be performed through the procedure more than about 6 steps. Because of this, pairing between the head unit of the vehicle and the mobile terminal is complicated, and accordingly, it is very cumbersome for the user of the vehicle to use the Bluetooth communication.

### SUMMARY OF THE INVENTION

The object of the present disclosure is to provide a Bluetooth pairing method using a wired connection, which a Bluetooth connection screen showing information of a head unit in a mobile terminal is automatically executed, if the head unit of a vehicle and the mobile terminal are connected through a cable.

A Bluetooth pairing method using a wired connection according to an embodiment of the present inventive concept comprises steps of: connecting a mobile terminal and an infotainment system of a vehicle by a wired connection; inputting a control signal starting a Bluetooth pairing; executing a dedicated application for a Bluetooth pairing provided in the mobile terminal by a controller provided in the infotainment system; transmitting information of the infotainment system for the Bluetooth pairing to the dedicated application by the controller; and automatically executing a connection screen for the Bluetooth pairing by controlling the mobile terminal based on the information by the dedicated APP, wherein the connection screen is a screen displaying the information of the infotainment system, so that the infotainment system and the mobile terminal are Bluetooth paired by a selection of the mobile terminal's user.

In an embodiment, in the step of connecting by a wire connection, the mobile terminal and the infotainment system are connected through Universal Serial Bus(USB).

In an embodiment, the information of the infotainment system for the Bluetooth pairing includes a Media Access control (MAC) address of the infotainment system or information for a Bluetooth module provided in the infotainment system.

In an embodiment, after the control signal is inputted, the method further comprises steps of: determining whether the dedicated application for the Bluetooth pairing is provided to the mobile terminal or not by the controller; and transmitting and installing the dedicated application to the mobile terminal by the controller, if the dedicated APP is not provided to the mobile terminal as a result of the determination.

In an embodiment, the dedicated APP transmits the transmitted information of the infotainment system to a Bluetooth module provided in the mobile terminal by NTAG method.

In an embodiment, the method further comprises steps of selecting the infotainment system exposed on the connection screen; and Bluetooth pairing the infotainment system and the mobile terminal.

In an embodiment, the method further comprises step of storing the information to a Near Field Communication (NFC) tag by the dedicated application.

The Bluetooth pairing method using a wired connection according to the present inventive concept can automatically execute the Bluetooth connection screen showing the information of the head unit in the mobile terminal, if the head unit of a vehicle and the mobile terminal are connected through a cable.

### BRIEF DESCRIPTION OF THE DRAWINGS

The above and other objects, features and advantages of the present inventive concept will be more apparent from the following detailed description taken in conjunction with the accompanying drawings, in which:

FIG. 1 is a diagram showing a head unit of a vehicle and a mobile terminal, in a Bluetooth pairing method using a wired connection according to an embodiment of the present inventive concept.

FIG. 2 is a diagram showing a Bluetooth pairing method using a wired connection according to an embodiment of the present inventive concept.

### DETAILED DESCRIPTION OF THE PREFERRED EMBODIMENTS

The advantage and features of the present invention and how to achieve it will be explained through embodiments described in detail with the accompanying drawings. However, the invention is not limited to embodiments described herein and may be embodied in other aspects. Only, the present embodiment is provided for explaining to those skilled in the art to which this invention pertains in detail to the extent that it is possible to easily embody the technical spirit of the present invention.

In the drawings, embodiments of the present inventive concept are not limited to the shown specific aspects and are exaggerated in order to clarify. Although specific terms are used herein, it is only used for explaining the present invention, and it is not used for limiting the meaning or the scope of the present invention described in the claims.

The expression “and/or” herein is used as the meaning including at least one of components listed before and after the expression. Also, the expression “connected/coupled” is used as the meaning including being directly connected with another component or indirectly connected through another component. A singular form herein also includes a plural form unless it is specially referred in a phrase. Also, the components, steps, operations and elements referred as “comprise” or “comprising” used herein mean the presence or addition of at least one of other components, steps, operations and elements.

Hereinafter, with reference to the drawings an embodiment of the present invention will be described in detail.

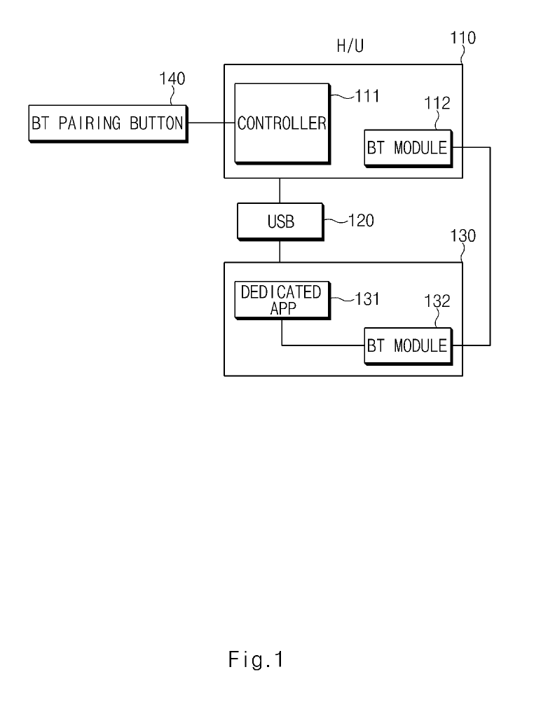

FIG. 1 is a diagram showing a head unit of a vehicle and a mobile terminal, in a Bluetooth pairing method using a wired connection according to an embodiment of the present inventive concept.

Referring to FIG. 1, a head unit (H/U) 110 of a vehicle is shown as an infotainment system of a vehicle, and a smart phone 130 is shown as a mobile terminal. However, the head unit 110 of a vehicle is not limited only to the infotainment system of a vehicle and the mobile terminal is not limited only to the smart phone, and the above examples are just for explaining the invention in detail conveniently.

The head unit 110 includes a controller 111 and a Bluetooth module 112, and the smart phone 130 includes a dedicated APP 131 and a Bluetooth module 132. Here, the head unit 110 receives an input signal for a Bluetooth pairing between the head unit 110 and the smart phone 130 through a Bluetooth pairing button 140. The Bluetooth pairing button 140 is the device which the user of a vehicle or smart phone 130 can operate, and it can be a touchable display mean provided in the head unit 110, or be a button provided in a steering wheel of a vehicle.

In the Bluetooth pairing method using a wired connection according to the present inventive concept, the head unit 110 of a vehicle is connected with the smart phone 130 via a wired connection, also Bluetooth paired, and thus a Bluetooth communication is possible. Concretely, the wired connection via which the head unit 110 of a vehicle and the smart phone 130 are connected may be Universal Serial Bus (USB) 120. That is, recently, “phone connectivity” connecting the mobile terminal such as the smart phone 130 with the infotainment system of a vehicle is the latest trend, and thus a connector, etc. capable of connecting a USB cable is provided in the inside of a vehicle. Accordingly, since the driver's vehicle is a reliable vehicle in security or in system configuration unlike other vehicle, the driver (user) of the vehicle can connect the smart phone 130 with the reliable head unit 110 of his vehicle with the USB 120.

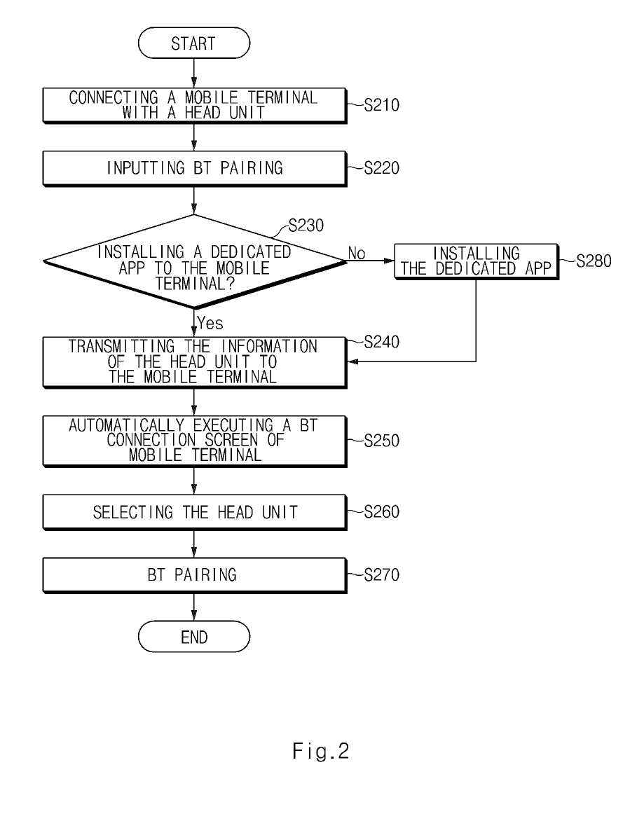

The detailed description will be explained with reference to FIG. 2 additionally.

FIG. 2 is a diagram showing a Bluetooth pairing method using a wired connection according to an embodiment of the present inventive concept. Referring to FIG. 2, the Bluetooth pairing method using a wired connection includes step S210 to step S280.

First, the smart phone 130 which is a mobile terminal is connected with the head unit 110 which is an infotainment system of a vehicle via a wired connection (S210). Here, the wired connection may be the connection through USB 120.

After that, the control signal starting a Bluetooth pairing is inputted (S220). Here, the control signal starting the Bluetooth pairing can be inputted by operating the Bluetooth pairing button 140 provided in the steering wheel of the vehicle by the vehicle's user, and also if the display provided in the head unit 110 itself is the device capable of receiving a touch input, it can be inputted through the touch of the screen provided in the head unit 110.

After that, the head unit 110 of the vehicle receiving the control signal inputted in step S220 transmits the received signal to the controller 111 provided in its inside, and the controller 111 executes the dedicated APP 131 provided (installed) in the smart phone 130 through the connected USB 120. Here, the dedicated APP 131 may be the APP (application) capable of controlling the smart phone 130 for a Bluetooth pairing between the smart phone 130 and the Bluetooth module (112, 132) provided in the head unit 110.

Also, the controller 111 can determine whether the dedicated APP 131 for a Bluetooth pairing to the smart phone 130 is provided or not (S230), and as the result of the determination, if the dedicated APP 131 is not provided in the smart phone 130, the controller 111 transmits the dedicated APP 131 for a Bluetooth connection to the smart phone 130 through a wired connection, and then the transmitted, dedicated APP 131 can be installed in the smart phone 130 (S280).

After that, if the dedicated APP 131 for a Bluetooth connection to the smart phone 130 is executed, the controller 111 transmits the information of the head unit 110 required for a Bluetooth connection to the smart phone 130 (S240). Here, the information of the head unit 110 required for a Bluetooth connection may include a Media Access Control (MAC) address of head unit 110 or the information for the Bluetooth module 112 provided in the head unit 110.

After that, based on the information received in step S240, the dedicated APP 131 controls the smart phone 130 so that the smart phone 130 and the head unit 110 can be Bluetooth paired, and thus the connection screen for a Bluetooth pairing is automatically executed (S250). Here, the connection screen may be the screen exposing and outputting the information of the head unit 110 to the user, so that the head unit 110 and the smart phone 130 are Bluetooth paired by the simple selection (for example, one-time touch input) of the user of the smart phone 130. Here, the dedicated APP 131 can execute the connection screen by controlling the Bluetooth module 132 provided in the smart phone 130, and transmit the information of the head unit 110 received in step S240 to the Bluetooth module 132 provided in the smart phone 130 by a NTAG method.

After that, the user of the vehicle or the smart phone 130 can select the head unit 110 displayed on the connection screen executed and provided in step S250 (S260), and the dedicated APP 131 can control the Bluetooth module 112, 132 each provided in them, so that the selected head unit 110 and the smart phone 130 are Bluetooth paired (S270).

And, if the user of the vehicle or the smart phone attempts a Bluetooth connection by using Near Field Communication (NFC), the dedicated APP 131 can store the information of the head unit 110 received from the head unit 110 through the USB one time only. In this way, if the information of the head unit 110 is stored in a NFC tag, the user of the vehicle or the smart phone can connect the smart phone 130 with the head unit 110 of the stored information by NFC tagging without connecting a USB cable to the smart phone 130.

After all, the Bluetooth pairing method using a wired connection according to an embodiment of the present inventive concept connects the infotainment system of a vehicle with a smart phone through a wired connection (for example, USB) provided in the vehicle, and only by operating a Bluetooth pairing button, the Bluetooth connection screen exposing the infotainment system provided in the current vehicle can be outputted automatically. That is, the user of a vehicle or a mobile terminal can easily obtain a Bluetooth connection by pressing a steering wheel button once and pressing a connection screen once.

In the above description, the present inventive concept has been described through specific examples, but it may be well understood that various modifications can be made without departing from the scope of the present invention. Therefore, the scope of the present inventive concept is not limited to the above described embodiments, and it should be defined by the appended claims and their equivalents. When taking the foregoing description into account, if the modifications and variations of the present inventive concept fall within the following claims and their equivalents, then it is construed that the present inventive concept includes these modifications and variations.

What is claimed is:

1. A Bluetooth pairing method using a wired connection comprising steps of:
connecting a mobile terminal and an infotainment system of a vehicle via a wired connection;
inputting a control signal starting a Bluetooth pairing;
executing a dedicated application for a Bluetooth pairing provided in the mobile terminal by a controller provided in the infotainment system;
transmitting information of the infotainment system for the Bluetooth pairing to the dedicated application by the controller; and
automatically executing a connection screen for the Bluetooth pairing by controlling the mobile terminal based on the information by the dedicated application,
wherein the connection screen is a screen displaying the information of the infotainment system.

2. The Bluetooth pairing method using a wired connection according to claim 1, wherein in the step of connecting by a wire connection, the mobile terminal and the infotainment system are connected through Universal Serial Bus (USB).

3. The Bluetooth pairing method using a wired connection according to claim 1, wherein the information of the infotainment system for the Bluetooth pairing includes a Media Access control (MAC) address of the infotainment system or information for a Bluetooth module provided in the infotainment system.

4. The Bluetooth pairing method using a wired connection according to claim 1, wherein after the control signal is inputted, the method further comprises steps of:
determining whether the dedicated application for the Bluetooth pairing is provided to the mobile terminal or not by the controller; and
transmitting and installing the dedicated application to the mobile terminal by the controller, if the dedicated application is not provided to the mobile terminal as a result of the determination.

5. The Bluetooth pairing method using a wired connection according to claim 1, wherein the dedicated application transmits the transmitted information of the infotainment system to a Bluetooth module provided in the mobile terminal by NTAG method.

6. The Bluetooth pairing method using a wired connection according to claim 1, wherein the method further comprises steps of:
selecting the infotainment system displayed on the connection screen; and
Bluetooth pairing the infotainment system and the mobile terminal.

7. The Bluetooth pairing method using a wired connection according to claim 1, wherein the method further comprises a step of storing the information to a Near Field Communication (NFC) tag by the dedicated application.

8. The Bluetooth pairing method using a wired connection according to claim 1, wherein the infotainment system and the mobile terminal are Bluetooth paired by a selection of the mobile terminal's user
